(19) United States
(12) Patent Application Publication
(10) Pub. No.: US 2014/0379792 A1
(43) Pub. Date: Dec. 25, 2014

(54) INFORMATION PROCESSING APPARATUS AND RECORDING MEDIUM

(71) Applicant: FUJITSU LIMITED, Kawasaki-shi (JP)

(72) Inventors: Tomohiro MURAYAMA, Yokohama (JP); Kazuo MIZUTA, Miyaki (JP); Takeshi UENO, Yokohama (JP)

(21) Appl. No.: 14/481,157

(22) Filed: Sep. 9, 2014

Related U.S. Application Data
(63) Continuation of application No. PCT/JP2012/058423, filed on Mar. 29, 2012.

(51) Int. Cl. H04L 29/06

(52) U.S. Cl. CPC H04L 67/42
USPC 709/203

(57) ABSTRACT

An information processing apparatus that is capable of communicating with a plurality of servers includes: a storage unit to store a network response table describing a network response time, the network response time being a time period from transmission of a request to establish a connection to a server to reception of a response to the request to establish the connection, and a server response table describing a server response time, the server response time being a time period from transmission of a request to write data to the server to reception of a response indicating a completion of writing the data; and a processor to generate pieces of divided data by dividing writing data, select, in accordance with the network response time or the server response time, saving servers, and transmit the pieces of the divided data to the saving servers.

### CROSS-REFERENCE TO RELATED APPLICATION

This application is a continuation application of International Application PCT/JP2012/058423 filed on Mar. 29, 2012 and designated the U.S., the entire contents of which are incorporated herein by reference.

### FIELD

The embodiments discussed herein are related to an information processing apparatus and a recording medium.

### BACKGROUND

Presently, what is called cloud computing, i.e., a configuration wherein computer resources (e.g., servers, storages, and applications) are used over a network, is being performed.

In cloud computing, users perform various tasks using clients such as personal computers.

A user saves data in a cloud server for providing services.

In the saving of data in a cloud server, a client typically saves the data in a predetermined data center within the cloud server.

However, an occurrence of a processing delay caused by intensive access to the data center from many clients, or a network delay caused by a network failure between clients and the data center or caused by too many packets leads to a data saving process that takes a long time to complete.

Furthermore, the documents such as Japanese Laid-open Patent Publication No. 2006-332825, Japanese Laid-open Patent Publication No. 2006-301849, and Japanese Laid-open Patent Publication No. 10-283296, etc. are well known.

### SUMMARY

According to an aspect of the invention, an information processing apparatus can communication with a plurality of servers and includes a storage unit and a processor.

The storage unit includes: a network response table describing a network response time, the network response time being a time period from transmission of a request to establish a connection to a server to reception of a response to the request to establish the connection; and a server response table describing a server response time, the server response time being a time period from transmission of a request to write data to the server to reception of a response indicating a completion of writing the data.

The processor generate pieces of divided data by dividing writing data.

In accordance with the network response time or the server response time, the processor selects saving servers in which the pieces of divided data are to be saved.

The processor transmits the pieces of divided data to the saving servers.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OP THE DRAWINGS

FIG. 1 is a configuration diagram of a system in accordance with an embodiment;

FIG. 2 is a configuration diagram of a client in accordance with an embodiment;

FIG. 3 illustrates an example of data-center configuration information;

FIG. 4 illustrates an example of an NW response table;

FIG. 5 illustrates an example of a sorted NW response table;

FIG. 6 illustrates an example of a server response table;

FIG. 7 illustrates an example of a sorted server response table;

FIG. 8 illustrates an example of a sorted free-disk-capacity table;

FIG. 9 illustrates an example of a data-division condition table;

FIG. 10 illustrates an example of a divided-data management table;

FIG. 11 is a configuration diagram of a management server in accordance with an embodiment;

FIG. 12 illustrates an example of a free-disk-capacity table;

FIG. 13 is a configuration diagram of a data center in accordance with an embodiment;

FIG. 14 is a sequence diagram of a process of measuring a network response time and a server response time;

FIG. 15 is a flowchart of a data saving process performed by a client in accordance with an embodiment;

FIG. 16 is a sequence diagram of a process from obtainment of data-center configuration information to obtainment of a sorted table in accordance with an embodiment;

FIG. 17 is a flowchart of a process performed by a management server in accordance with an embodiment;

FIG. 18 is a sequence diagram of a process of obtaining information on a free disk capacity in accordance with an embodiment;

FIG. 19 is a flowchart of a client response process performed by a data center in accordance with an embodiment;

FIG. 20 is a flowchart of a management-server response process performed by a data center in accordance with an embodiment;

FIG. 21 illustrates a sorted free-disk-capacity table;

FIG. 22 illustrates a sorted NW response table;

FIG. 23 illustrates a divided-data management table;

FIG. 24 illustrates a sorted free-disk-capacity table;

FIG. 25 illustrates a sorted server response table;

FIG. 26 illustrates a divided-data management table; and

FIG. 27 is a configuration diagram of an information processing apparatus (computer).

### DESCRIPTION OF EMBODIMENTS

The following will describe embodiments with reference to the drawings.

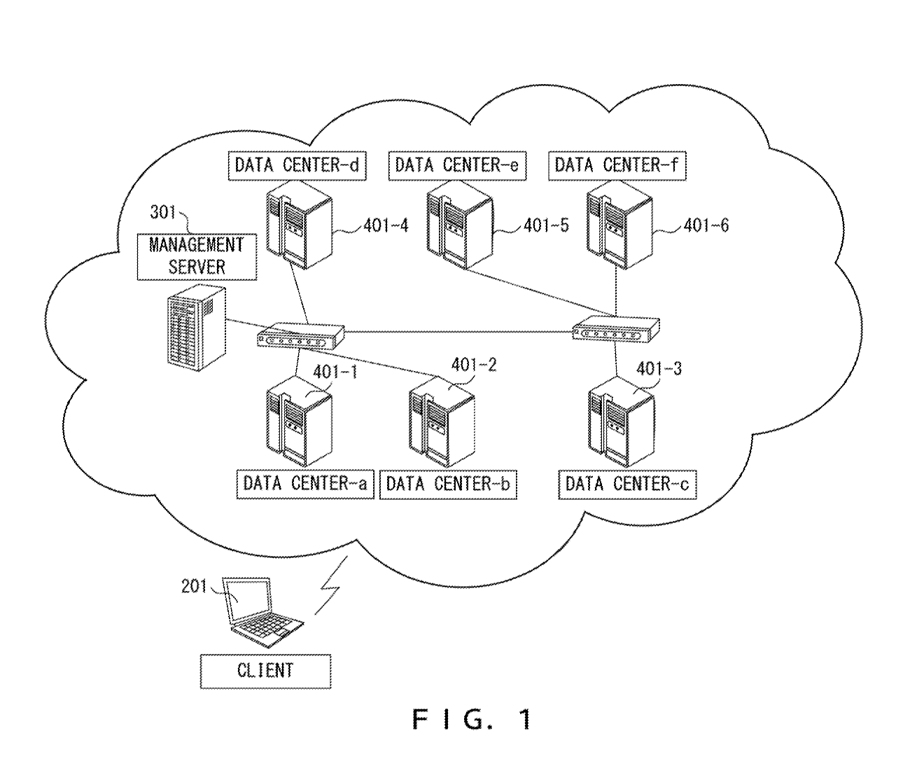

FIG. 1 is a configuration diagram of a system in accordance with an embodiment.

A system 101 includes a client 201, a management server 301, and data centers 401-i (i=1 to 6).

The client 201, the management server 301, and the data centers 401 are connected to each other over a network and can communicate with each other.

The client 201 performs various processes and saves data in the data center 401.

The client 201 is an information processing apparatus, e.g., a personal computer or mobile terminal.

The management server 301 collects and manages information from the data centers 401.

The data centers 401 are servers for storing data. The data centers 401 write or read data requested by the client 201.

“data center-a” to “data center-f” are respectively allocated to the data centers 401-1 to 401-6 as server IDs. The server ID is an identifier of a data center 401.

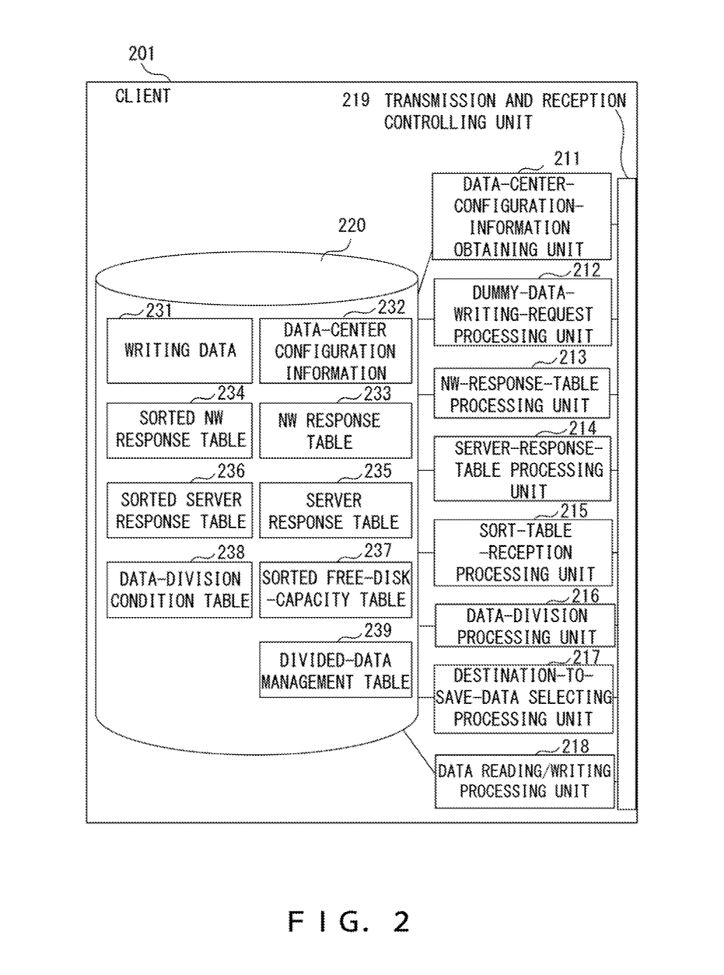

FIG. 2 is a configuration diagram of a client in accordance with an embodiment.

The client 201 includes a data-center-configuration-information obtaining unit 211, a dummy-data-writing-request processing unit 212, a network (NW)-response-table processing unit 213, a server-response-table processing unit 214, a sort-table-reception processing unit 215, a data-division processing unit 216, a destination-to-save-data selecting processing unit 217, a data reading/writing processing unit 218, a transmission and reception controlling unit 219, and a storage unit 220.

The data-center-configuration-information obtaining unit 211 obtains data-center configuration information 321 from the management server 301 and stores this information in the storage unit 220 as data-center configuration information 232.

The dummy-data-writing-request processing unit 212 transmits a connection request or a dummy-data writing request to the data center 401.

The NW-response-table processing unit 213 measures an NW response time and generates an NW response table 233.

The server-response-table processing unit 214 measures a server response time and generates a server response table 235.

The sort-table-reception processing unit 215 receives and stores a sorted NW response table, a sorted server response table, and a sorted free-disk-capacity table in the storage unit 220.

The data-division processing unit 216 divides writing data 231 into pieces of divided data.

In accordance with at least one of a network response time, a server response time, or a free disk capacity, the destination-to-save-data selecting processing unit 217 decides on (selects) saving data centers in which pieces of divided data are to be saved.

In one possible example, the destination-to-save-data selecting processing unit 217 selects, as saving data centers, a predetermined number of (e.g., ten) data centers starting from the data center having the fastest network response time.

In another possible example, the destination-to-save-data selecting processing unit 217 selects, as saving data centers, a predetermined number of (e.g., ten) data centers starting from the data center having the fastest server response time.

In one possible example, the destination-to-save-data selecting processing unit 217 does not select, as a saving data center, a data center whose free disk capacity is equal to or smaller than a predetermined capacity. That is, the destination-to-save-data selecting processing unit 217 selects, as a saving data center, a data center whose free disk capacity is larger than the predetermined capacity.

The destination-to-save-data selecting processing unit 217 cyclically selects (allocates) a saving data center to each piece of divided data. “Cyclically select” means that a list of saving data centers is provided wherein the saving data centers are ordered starting from the saving data center with the fastest network response time or server response time; saving data centers are selected from the list in order starting from the top of the list; when the saving data center at the bottom of the list is selected, then the saving data center at the top of the list is selected again (wraparound), and the flowing saving data centers are selected in order again.

When, for example, saving data centers α, β, and γ have network response times that go from faster to slower in this order, the destination-to-save-data selecting processing unit 217 selects a saving data center for each piece of divided data in order of α→β→γ→α→β→γ→ • • •.

The destination-to-save-data selecting processing unit 217 creates a divided-data management table 239.

The data reading/writing processing unit 218 transmits pieces of divided data to and receives pieces of divided data from data centers 401. The data reading/writing processing unit 218 combines pieces of received divided data.

The transmission and reception controlling unit 219 receives data from the data-center-configuration-information obtaining unit 211, the dummy-data-writing-request processing unit 212, the NW-response-table processing unit 213, the server-response-table processing unit 214, the sort-table-reception processing unit 215, the data-division processing unit 216, the destination-to-save-data selecting processing unit 217, and the data reading/writing processing unit 218, and transfers the received data to the management server 301 or the data center 401. The transmission and reception controlling unit 219 receives data from the management server 301 or the data center 401 and transfers the data to the data-center-configuration-information obtaining unit 211, the dummy-data-writing-request processing unit 212, the NW-response-table processing unit 213, the server-response-table processing unit 214, the sort-table-reception processing unit 215, the data-division processing unit 216, the destination-to-save-data selecting processing unit 217, or the data reading/writing processing unit 218.

The storage unit 220 is an apparatus for storing data. The storage unit 220 is, for example, a magnetic disk apparatus, semiconductor storage device, or Random Access Memory (RAM).

The storage unit 220 stores writing data 231, data-center configuration information 232, the network (NW) response table 233, a sorted NW response table 234, the server response table 235, a sorted server response table 236, a sorted free-disk-capacity table 237, a data-division condition table 238, and a divided-data management table 239.

Writing data 231 is data before division that is to be written to the data center 401. Writing data 231 is generated by, for example, application software operated by the client 201.

Data-center configuration information 232 is information on a data center 401 located within the system 101.

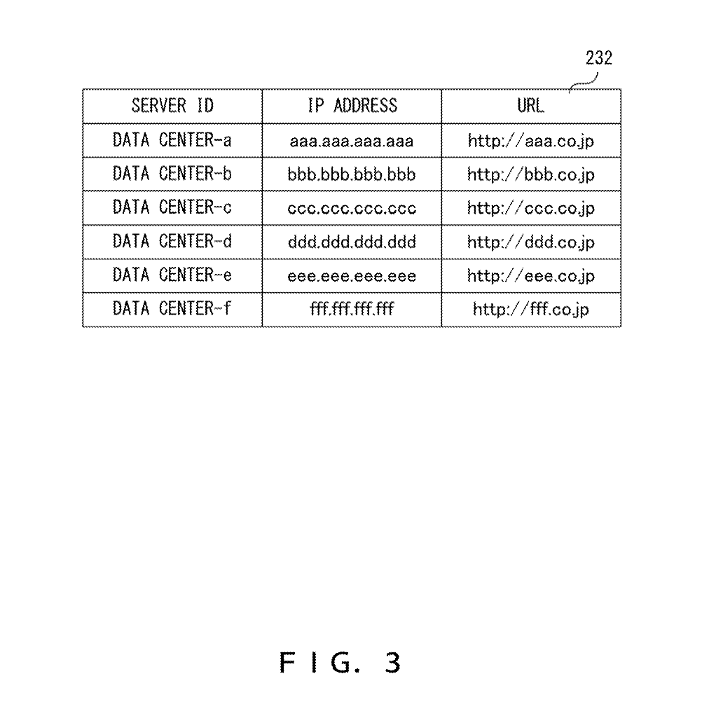

FIG. 3 illustrates an example of data-center configuration information.

Data-center configuration information 232 includes the fields “server ID”, “Internet Protocol (IP) address”, and “Uniform Resource Locator (URL)”. Data-center configuration information 232 describes a server ID, an IP address, and a URL in association with each other.

“server ID” indicates an identifier of a data center 401.

“IP address” indicates the IP address of the data center 401.

“URL” indicates the URL of the data center 401.

The network (NW) response table 233 describes a network response time for a communication between the client 201 and a data center 401. The network response time is a time period from a time when the client 201 transmits a connection request (SYN packet) to the data center 401 to a time when the client 201 receives an ACK (ACK packet). Details of the network response time will be described hereinafter.

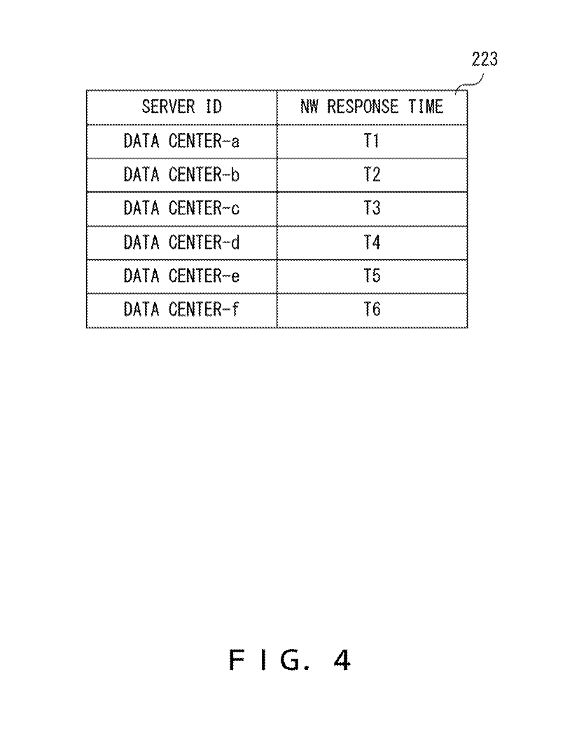

FIG. 4 illustrates an example of an NW response table.

The NW response table 233 includes the fields “server ID” and “NW response time”. The NW response table 233 describes a server ID and an NW response time in association with each other.

“server ID” indicates an identifier of a data center 401.

“NW response time” indicates a network response time for a communication between the client 201 and the data center 401. NW response times are expressed in millisecond (ms).

The sorted NW response table 234 is the same as a NW response table 322, which will be described hereinafter, but with the records within the NW response table 322 sorted in ascending order of NW response time.

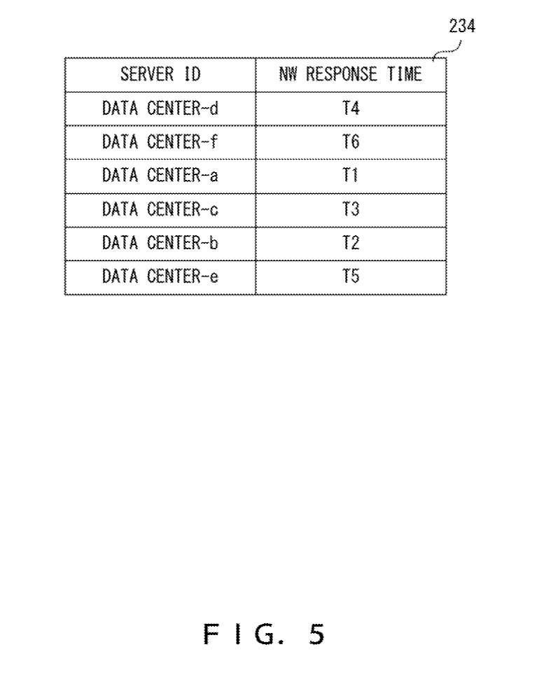

FIG. 5 illustrates an example of a sorted NW response table.

The sorted NW response table 234 includes the fields “server ID” and “NW response time”. The sorted NW response table 234 describes a server ID and an NW response time in association with each other.

“server ID” indicates an identifier of a data center 401.

“NW response time” indicates a network response time for a communication between the client 201 and the data center 401. NW response times are expressed in millisecond (ms).

The server response table 235 describes a server response time for a communication between the client 201 and the data center 401. The server response time is a time period from a time when the client 201 transmits a dummy-data writing request to the data center 401 to a time when the client 201 receives a response. Details of the server response time will be described hereinafter.

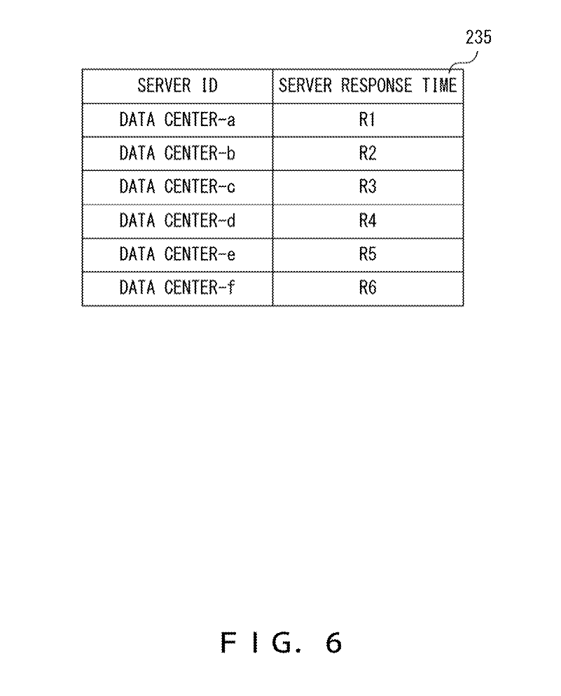

FIG. 6 illustrates an example of a server response table.

The server response table 235 includes the fields “server ID” and “server response time”. The server response table 235 describes a server ID and a server response time in association with each other.

“server ID” indicates an identifier of a data center 401.

“server response time” indicates a server response time for a communication between the client 201 and the data center 401. Server response times are expressed in millisecond (ms).

The sorted server response table 236 is the same as a server response table 323, which will be described hereinafter, but with the records within the server response table 323 sorted in ascending order of server response time.

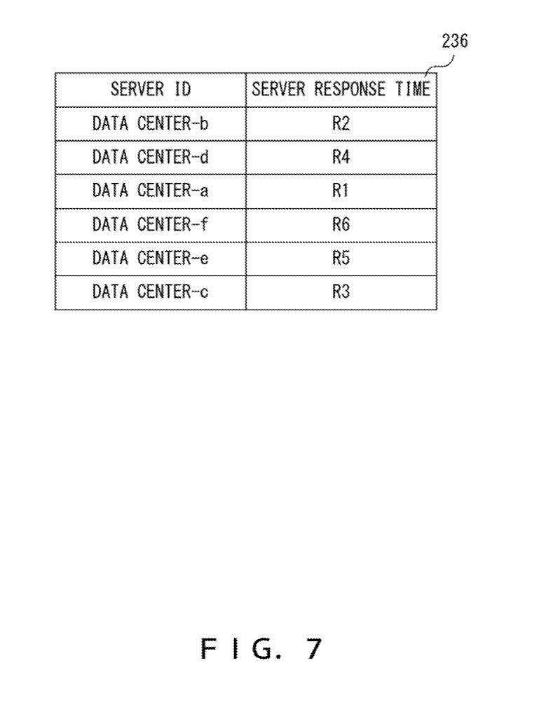

FIG. 7 illustrates an example of a sorted server response table.

The sorted server response table 236 includes the fields “server ID” and “server response time”. The sorted server response table 236 describes a server ID and a server response time in association with each other.

“server ID” indicates an identifier of a data center 401.

“server response time” indicates a server response time for a communication between the client 201 and the data center 401. Server response times are expressed in millisecond (ms).

The sorted free-disk-capacity table 237 is the same as a free-disk-capacity table 324, which will be described hereinafter, but with the records within the free-disk-capacity table 324 sorted in descending order of free disk capacity. The sorted free-disk-capacity table 237 describes the free disk capacity of a data center 401.

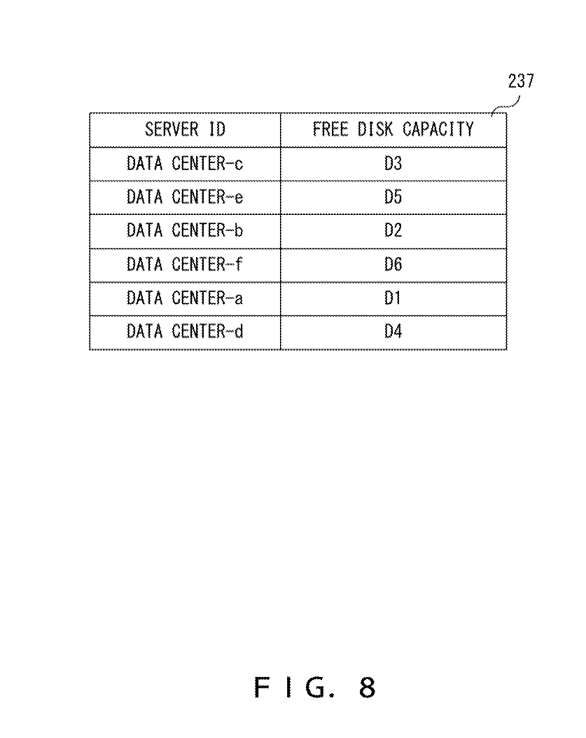

FIG. 8 illustrates an example of a sorted free-disk-capacity table.

The sorted free-disk-capacity table 237 includes the fields “server ID” and “free disk capacity”. The sorted free-disk-capacity table 237 describes a server ID and a free disk capacity in association with each other.

“server ID” indicates an identifier of a data center 401.

“free disk capacity” indicates the size of a free space of a storage unit of the data center 401. Free disk capacities are expressed in gigabyte (GB).

The data-division condition table 238 describes a course of action for the data-division processing unit 216 to divide data.

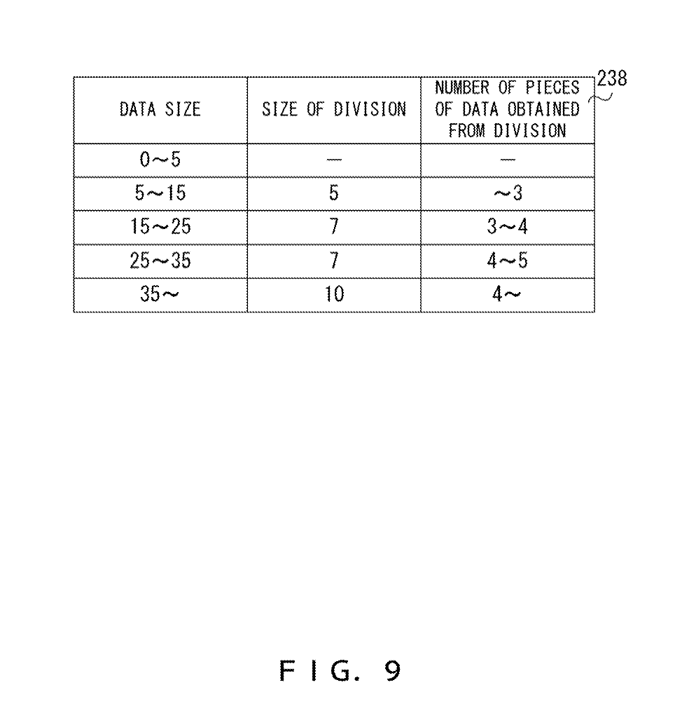

FIG. 9 illustrates an example of a data-division condition table.

The data-division condition table 238 includes the fields “data size”, “size of division”, and “number of pieces of data obtained from division”. The data-division condition table 238 describes a data size, a size of division, and the number of pieces of data obtained from division in association with each other.

“data size” indicates the size of division-target data. The data size is expressed in megabyte (MB).

“size of division” indicates the size of a piece of data obtained from division. The size of division is expressed in MB.

“number of pieces of data obtained from division” indicates the number of pieces of data obtained by dividing division-target data at the size of division.

As an example, the second line of the data-division condition table 238 depicted in FIG. 9 indicates that division-target data whose size is greater than 5 MB and equal to or less than 15 MB is divided into three or less pieces of divided data each having a size of 5 MB.

The divided-data management table 239 describes information indicating a location to save divided data.

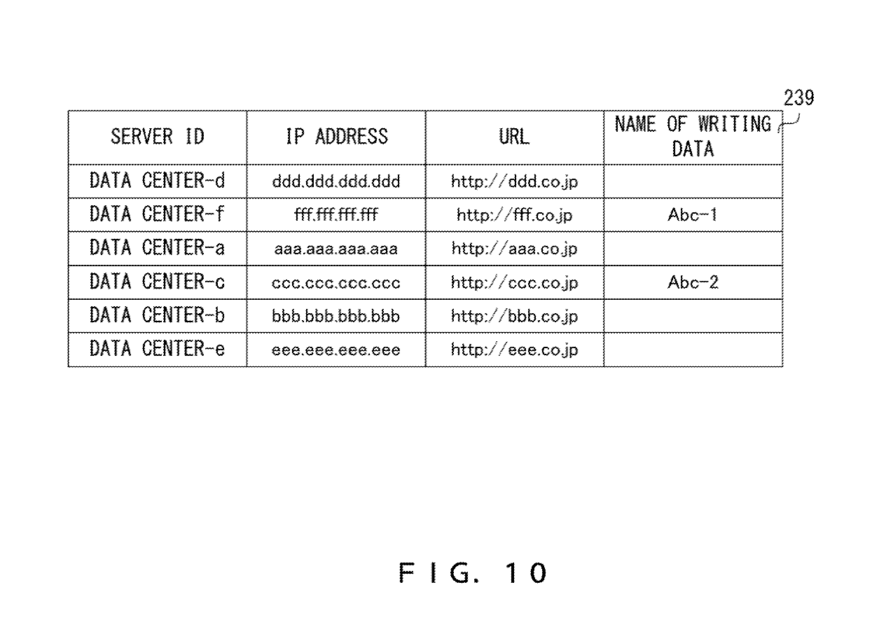

FIG. 10 illustrates an example of a divided-data management table.

The divided-data management table 239 includes the fields “server ID”, “IP address”, “URL”, and “name of writing data”. The divided-data management table 239 describes a server ID, an IP address, a URL, and the name of writing data in association with each other.

“server ID” indicates an identifier of a data center 401.

“IP address” indicates the IP address of the data center 401.

“URL” indicates the URL of the data center 401.

“name of writing data” indicates the name (file name) of divided writing data (divided data). The format of the name of writing data is “name of writing data 231”-“division number”. Division numbers are numbers allocated to pieces of divided data in order. As an example, the name of writing data “Abc-1” indicates a first piece of data included in the pieces of data obtained by dividing writing data 231 whose name is “Abc”.

For example, the second line of the divided-data management table 239 indicates that a data center whose server ID is “data center-f” has stored therein a piece of divided data whose name is “Abc-1”. That is, the data center whose server ID is “data center-f” has stored therein a first piece of data included in the pieces of data obtained by dividing writing data 231 whose name is “Abc”.

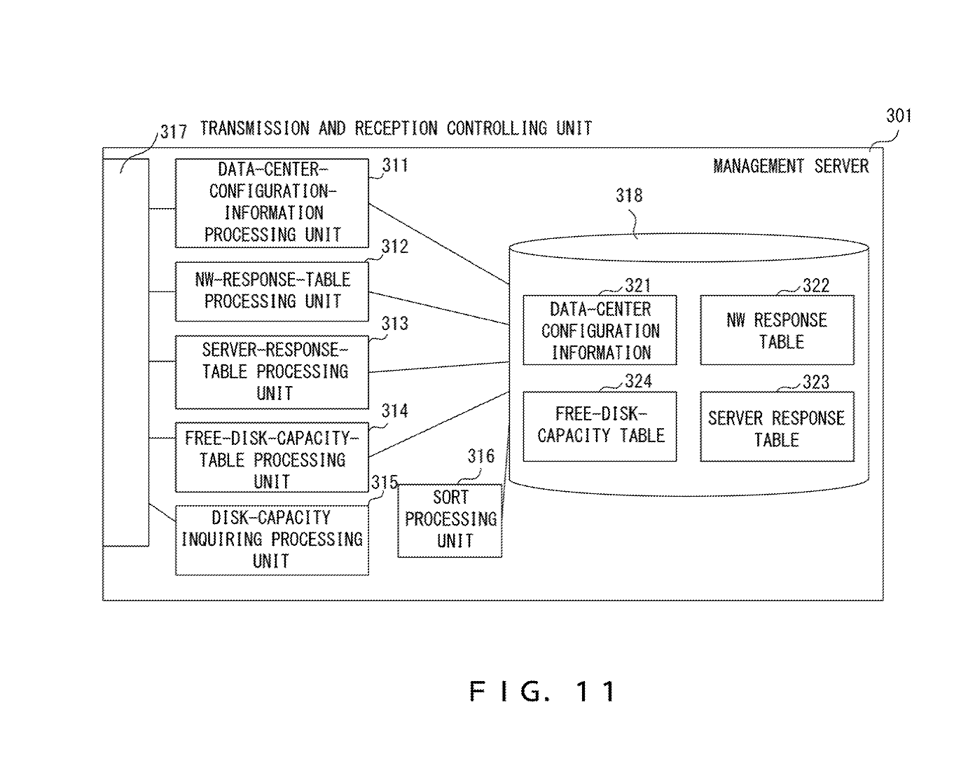

FIG. 11 is a configuration diagram of a management server in accordance with an embodiment.

The management server 301 includes a data-center-configuration-information processing unit 311, an NW-response-table processing unit 312, a server-response-table processing unit 313, a free-disk-capacity-table processing unit 314, a disk-capacity inquiring processing unit 315, a sort processing unit 316, a transmission and reception controlling unit 317, and a storage unit 318.

The data-center-configuration-information processing unit 311 transmits data-center configuration information 321 to the client 201.

The NW-response-table processing unit 312 receives the NW response table 233 from the client 201 and stores this table in the storage unit 318 as the NW response table 322.

The server-response-table processing unit 313 receives the server response table 235 from the client 201 and stores this table in the storage unit 318 as the server response table 323.

The free-disk-capacity-table processing unit 314 creates and updates the free-disk-capacity table 324.

The disk-capacity inquiring processing unit 315 inquires with the data center 401 about a free disk capacity and obtains information on the free disk capacity.

The sort processing unit 316 sorts records of the NW response table 322, the server response table 323, and the free-disk-capacity table 324.

The transmission and reception controlling unit 317 receives data from the data-center-configuration-information processing unit 311, the NW-response-table processing unit 312, the server-response-table processing unit 313, the free-disk-capacity-table processing unit 314, the disk-capacity inquiring processing unit 315, and the sort processing unit 316, and transfers the data to the client 201 or the data center 401. The transmission and reception controlling unit 317 also receives data from the client 201 or the data center 401 and transfers the data to the data-center-configuration-information processing unit 311, the NW-response-table processing unit 312, the server-response-table processing unit 313, the free-disk-capacity-table processing unit 314, the disk-capacity inquiring processing unit 315, or the sort processing unit 316.

The storage unit 318 is an apparatus for storing data. The storage unit 318 is, for example, a magnetic disk apparatus, semiconductor storage device, or RAM.

The storage unit 318 stores data-center configuration information 321, the NW response table 322, the server response table 323, and the free-disk-capacity table 324.

Data-center configuration information 321 is information on a data center 401 provided within the system 101. The format of data-center configuration information 321 is similar to that of data-center configuration information 232, and hence descriptions thereof are omitted herein.

The NW response table 322 describes a server response time for a communication between the client 201 and the data center 401. The format of the NW response table 322 is similar to that of the NW response table 233, and hence descriptions thereof are omitted herein.

The server response table 323 describes a server response time for a communication between the client 201 and the data center 401. The server response time is a time period from a time when the client 201 transmits a dummy-data writing request to the data center 401 to a time when the client 201 receives a response. Details of the server response time will be described hereinafter. The format of the server response table 323 is similar to that of the server response table 235, and hence descriptions thereof are omitted herein.

The free-disk-capacity table 324 describes the size of a free disk capacity of the data center 401.

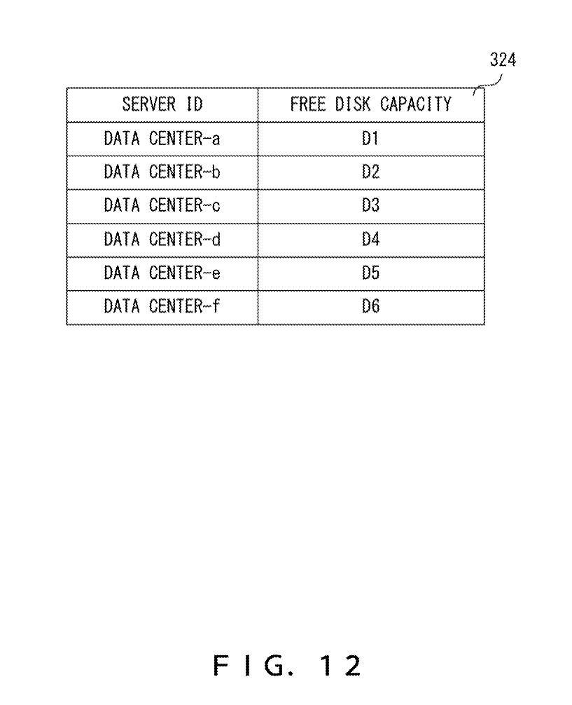

FIG. 12 illustrates an example of a free-disk-capacity table.

The free-disk-capacity table 324 includes the fields “server ID” and “free disk capacity”. The free-disk-capacity table 324 describes a server ID and a free disk capacity in association with each other.

“server ID” indicates an identifier of a data center 401.

“free disk capacity” indicates the size of a free space of a storage unit of the data center 401. Free disk capacities are expressed in gigabyte (GB).

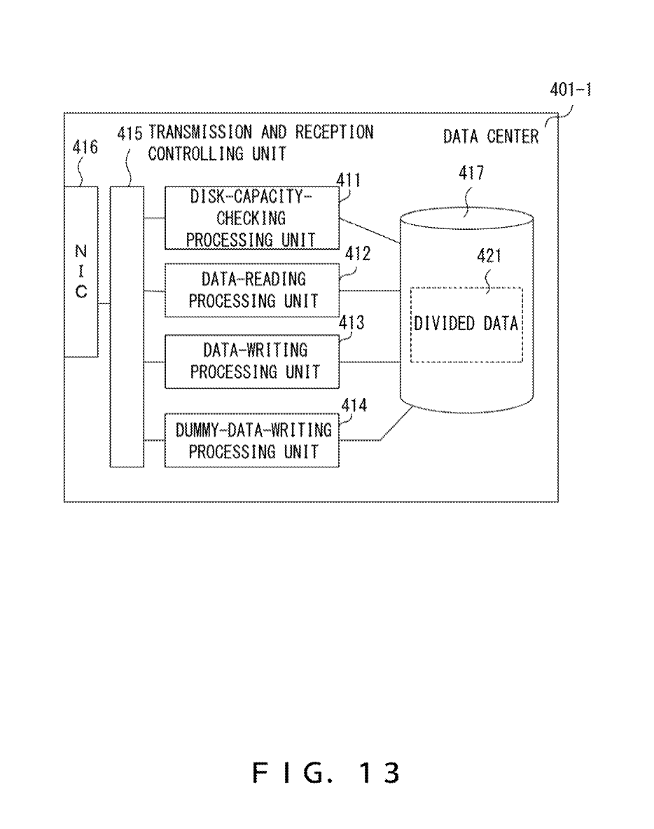

FIG. 13 is a configuration diagram of a data center in accordance with an embodiment.

The data center 401-1 includes a disk-capacity-checking processing unit 411, a data-reading processing unit 412, a data-writing processing unit 413, a dummy-data-writing processing unit 414, a transmission and reception controlling unit 415, a Network Interface Card (NIC) 416, and a storage unit 417.

The disk-capacity-checking processing unit 411 checks the size of a free capacity of the storage unit 417.

The data-reading processing unit 412 reads data from the storage unit 417.

The data-writing processing unit 413 writes data to the storage unit 417.

The dummy-data-writing processing unit 414 writes dummy data to the storage unit 417. Dummy data is data with a small size (e.g., 100 bytes). Dummy data includes arbitrary contents.

The transmission and reception controlling unit 415 receives data from the disk-capacity-checking processing unit 411, the data-reading processing unit 412, the data-writing processing unit 413, and the dummy-data-writing processing unit 414, and transfers the data to the NIC 416. The transmission and reception controlling unit 415 also receives data from the NIC 416 and transfers the data to the disk-capacity-checking processing unit 411, the data-reading processing unit 412, the data-writing processing unit 413, and the dummy-data-writing processing unit 414.

The NIC 416 is an expansion card to be connected to a network to communicate with the client 201 and the management server 301. The NIC 416 receives data from the client 201 or the management server 301 and transfers the data to the transmission and reception controlling unit 415. The NIC 416 also receives data from the transmission and reception controlling unit 415 and transfers the data to the client 201 or the management server 301. The NIC 416 transmits to the client 201 an ACK (ACK packet) that is a response to a connection request (SYN packet).

The storage unit 417 is an apparatus for storing data. The storage unit 417 is, for example, a magnetic disk apparatus, semiconductor storage device, or RAM.

The storage unit 417 stores divided data 421. Divided data 421 is a portion of divided writing data 231.

The configurations of the data centers 401-2 to 401-6 are similar to that of the data center 401-1, and hence descriptions thereof are omitted herein.

The following will describe the definitions of a network response time and a server response time, and will describe a process of measuring the times.

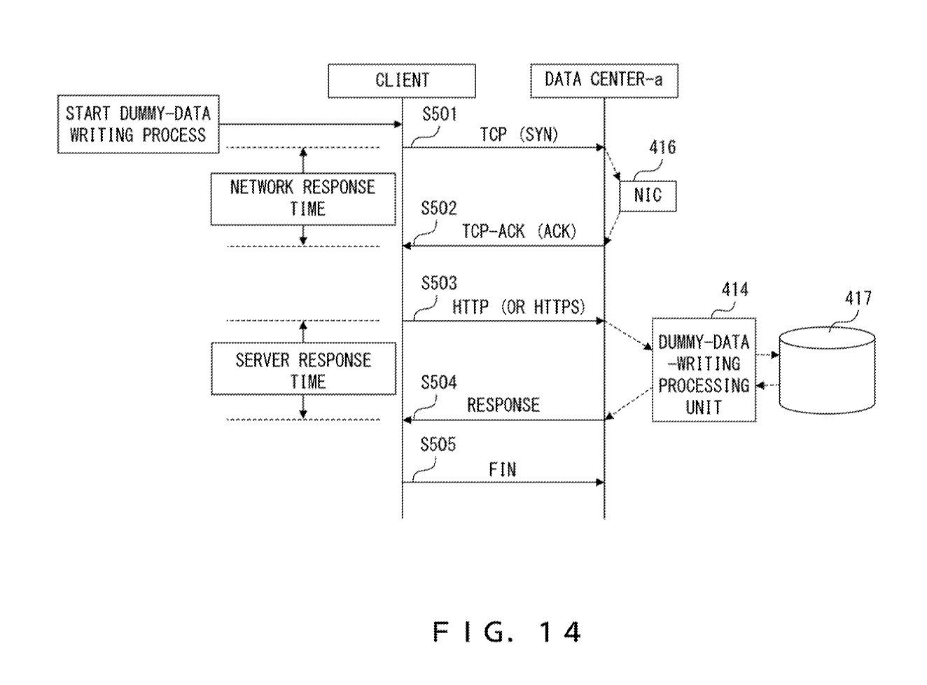

FIG. 14 is a sequence diagram of a process of measuring a network response time and a server response time.

First, descriptions will be given of measurement of the network response time and server response time of the data center 401-1.

The client 201 and the data center 401-1 communicate with each other using the Transmission Control Protocol (TCP).

The client 201 starts a dummy-data writing process. First, the client 201 transmits a connection request (SYN packet) to the data center 401-1 (S501).

The NIC 416 transmits to the client 201 an ACK (ACK packet) that is a response to the connection request (S502).

The client 201 receives the ACK (ACK packet).

The client 201 measures a time period from a time when the client 201 transmits the connection request (SYN packet) to a time when the client 201 receives the ACK (ACK packet), and defines this time period as a network response time.

The client 201 transmits a dummy-data writing request to the data center 401-1 using the HyperText Transfer Protocol (HTTP) or Hypertext Transfer Protocol over Secure Socket Layer (HTTPS) (S503).

Upon receipt of the dummy-data writing request, the dummy-data-writing processing unit 414 writes dummy data to the storage unit 417. When the writing process is completed, the dummy-data-writing processing unit 414 transmits a writing completion to the client 201 as a response (S504).

The client 201 receives the writing completion as a response.

The client 201 measures a time period from a time when the client 201 transmits the dummy-data writing request to a time when the client 201 receives the writing completion as a response, and defines this time period as a server response time.

The client 201 transmits a FIN packet to the data center 401-1 and terminates the communication (S505).

The processes of measuring network response times and server response times of the data centers 401-2 to 401-6 are similar to the process of measuring a network response time and server response time of the data center 401-1.

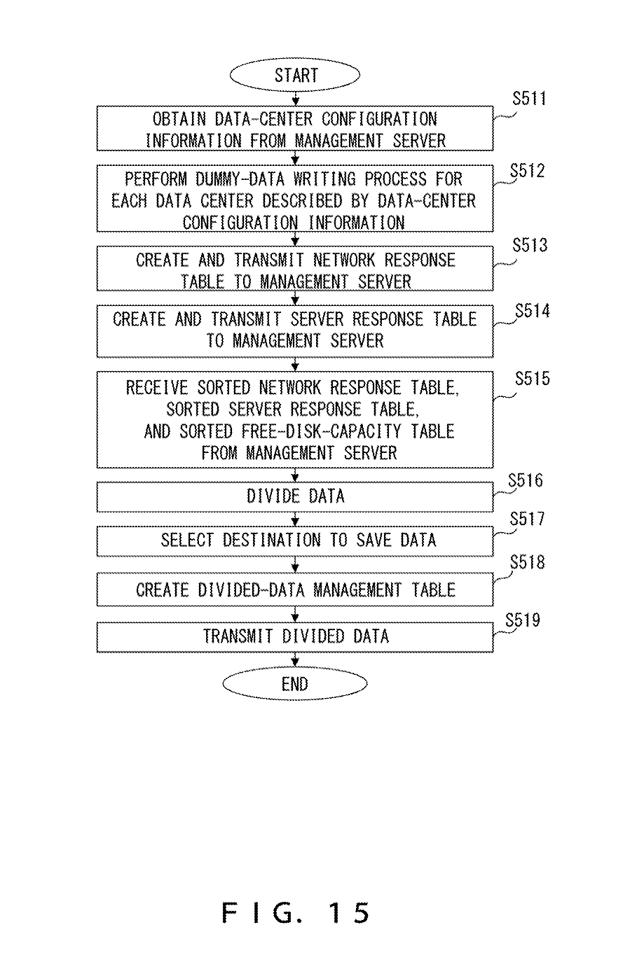

FIG. 15 is a flowchart of a data saving process performed by a client in accordance with an embodiment.

First, the client 201 generates writing data 231 in an application-software-based process and starts a data saving process for saving writing data 231.

In step S511, the data-center-configuration-information obtaining unit 211 transmits a data-center-configuration-information obtainment request to the management server 301, receives data-center configuration information 321 from the management server 301, and stores this information in the storage unit 220 as data-center configuration information 232.

In step S512, the dummy-data-writing-request processing unit 212 performs a dummy-data writing process for each data center 401 described in data-center configuration information 232 and measures an NW response time and server response time for each data center 401.

In step S513, the NW-response-table processing unit 213 creates a NW response table 233. In particular, the NW-response-table processing unit 213 stores server IDs and the measured NW response times in the NW response table 233 in association with each other. The NW-response-table processing unit 213 transmits the NW response table 233 to the management server 301.

In step S514, the server-response-table processing unit 214 creates a server response table 235. In particular, the server-response-table processing unit 214 stores server IDs and the measured server response times in the server response table 235 in association with each other. The server-response-table processing unit 214 transmits the server response table 235 to the management server 301.

In step S515, the sort-table-reception processing unit 215 receives a sorted NW response table, a sorted server response table, and a sorted free-disk-capacity table from the management server 301 and stores the sorted NW response table 234, the sorted server response table 236, and the sorted free-disk-capacity table 237 in the storage unit 220.

In step S516, the data-division processing unit 216 refers to the data-division condition table 238 and, in accordance with a condition described in the data-division condition table 238, divides writing data 231 into pieces of divided data.

In step S571, the destination-to-save-data selecting processing unit 217 refers to at least one of the sorted NW response table 234, the sorted server response table 235, or the sorted free-disk-capacity table 237 and, in accordance with a predetermined condition, selects data centers in which pieces of divided data are to be saved. The predetermined condition may be “NW response time has precedence”, “server response time has precedence”, or “free disk capacity that is greater than threshold”. A data center in which a piece of divided data is saved is referred to as a “saving data center” herein. Examples of selected saving data centers will be described hereinafter.

In step S518, the destination-to-save-data selecting processing unit 217 creates a divided-data management table 239. In particular, the destination-to-save-data selecting processing unit 217 stores the server ID of the saving data center and the name of a piece of divided data in the divided-data management table 239 in association with each other.

In step S519, the data reading/writing processing unit 218 transmits pieces of divided data to the saving data centers in accordance with the divided-data management table 239.

The following will describe details of the process from obtainment of data-center configuration information (step S511) to reception of sorted tables (step S515).

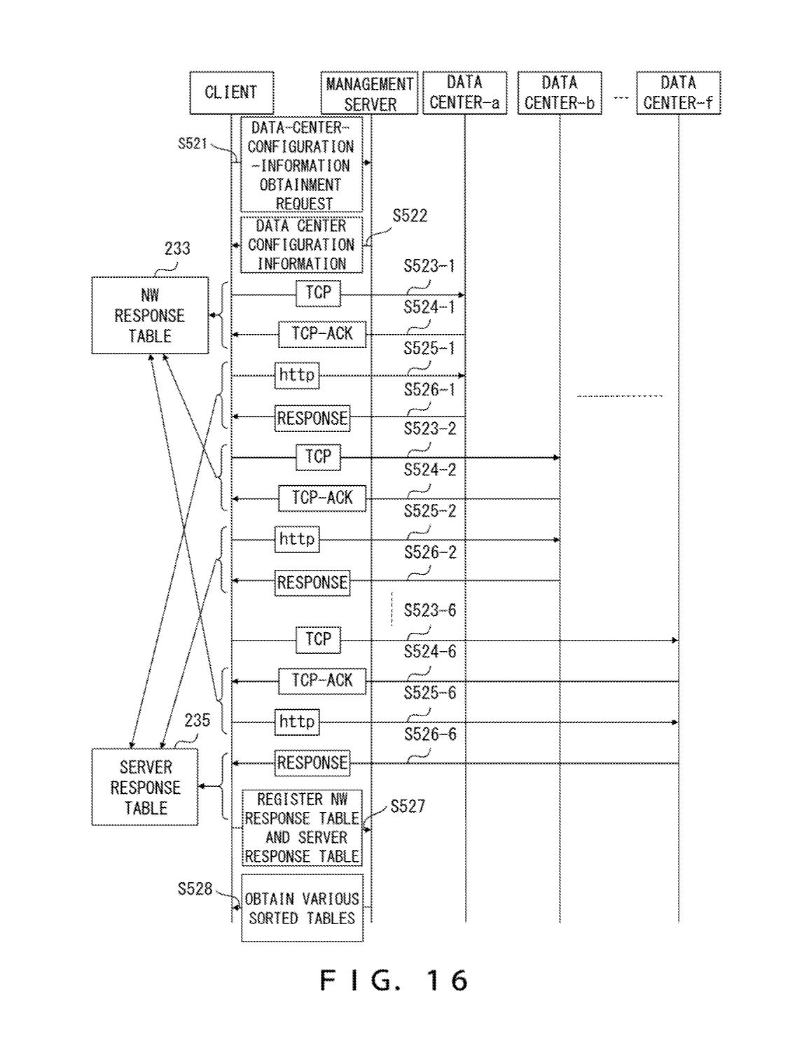

FIG. 16 is a sequence diagram of a process from obtainment of data-center configuration information to obtainment of sorted tables in accordance with an embodiment.

FIG. 16 corresponds to steps S511-S515 in FIG. 15.

The data-center-configuration-information obtaining unit 211 transmits a data-center-configuration-information obtainment request to the management server 301 (step S521).

Upon receipt of the data-center-configuration-information obtainment request, the data-center-configuration-information processing unit 311 transmits data-center configuration information 321 to the client 201 (step S522). The data-center-configuration-information obtaining unit 211 receives data-center configuration information 321. The data-center-configuration-information obtaining unit 211 stores data-center configuration information 321 in the storage unit 220 as data-center configuration information 232.

The dummy-data-writing-request processing unit 212 transmits a connection request (SYN packet) to the data center 401-1 (S523-1).

The NIC 416 transmits to the client 201 an ACK (ACK packet) that is a response to the connection request (S524-1).

The client 201 receives the ACK (ACK packet).

The NW-response-table processing unit 213 measures a time period from a time when the connection request (SYN packet) is transmitted to the data center 401-1 to a time when the ACK (ACK packet) is received, and stores this time period in the NW response table 233 as a network response time of the data center 401-1.

The dummy-data-writing-request processing unit 212 transmits a dummy-data writing request to the data center 401-1 using the HTTP or HTTPS (S525-1).

Upon receipt of the dummy-data writing request, the dummy-data-writing processing unit 414 writes dummy data to the storage unit 417. When the writing process is completed, the dummy-data-writing processing unit 414 transmits a writing completion to the client 201 as a response (5526-1).

The client 201 receives the writing completion as a response.

The server-response-table processing unit 214 measures a time period from a time when the client 201 transmits the dummy-data writing request to a time when the client 201 receives the writing completion as a response, and stores this time period in the server response table 235 as a server response time of the data center 401-1.

Similarly, NW response times and server response times of the data centers 401-2 to 401-6 are measured and stored in the NW response table 233 and the server response time table 235 (steps S523-2 to S526-6).

After the NW response table 233 and the server response table 235 are created, the NW-response-table processing unit 213 transmits the NW response table 233 to the management server 301, and the server-response-table processing unit 214 transmits the server response table 235 to the management server 301 (step S527).

The sort-table-reception processing unit 215 receives a sorted NW response table, a sorted server response table, and a sorted free-disk-capacity table from the management server 301 and stores the sorted NW response table 234, the sorted server response table 235, and the sorted free-disk-capacity table 237 in the storage unit 220 (step S528).

The following will describe a process performed by the management server 301.

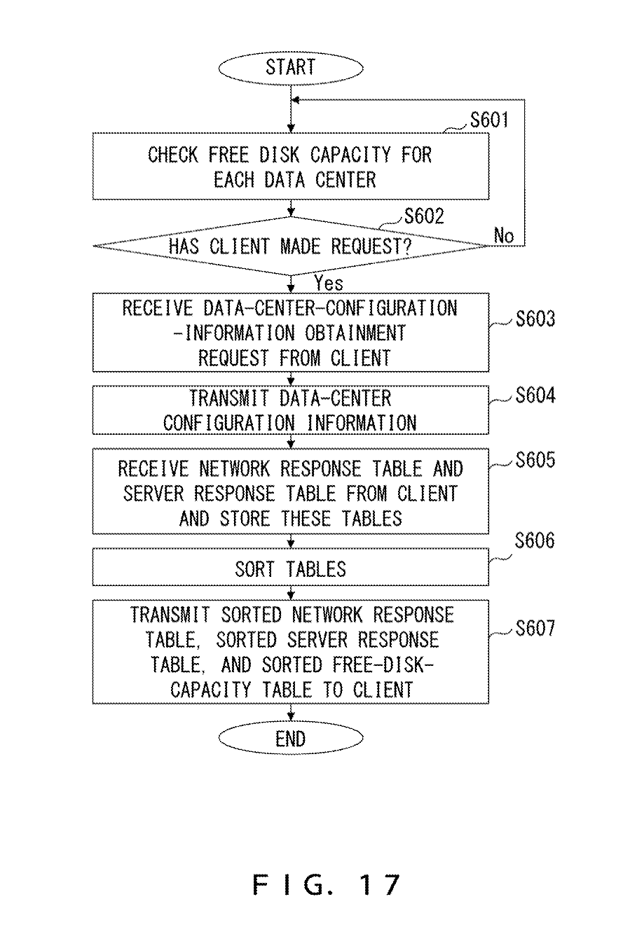

FIG. 17 is a flowchart of a process performed by a management server in accordance with an embodiment.

In step S601, the disk-capacity inquiring unit 315 checks a free disk capacity for each data center 401. In particular, the disk-capacity inquiring unit 315 transmits a free-disk-capacity checking request to inquire about a free disk capacity for each data center 401. The disk-capacity inquiring unit 315 receives a free-disk-capacity response (size of free disk capacity) from each individual data center 401. The free-disk-capacity-table processing unit 314 receives and stores information on free disk capacities in the free-disk-capacity table 324. Information on free disk capacities is periodically (e.g., hourly) obtained. Details of the obtaining of information on free disk capacities will be described hereinafter.

In step S602, when the client 201 makes a data-center-configuration-information obtainment request, the flow shits to step S603; otherwise, the flow returns to step S601.

In step S603, the data-center-configuration-information processing unit 311 receives a data-center-configuration-information obtainment request from the client 201.

In step S604, the data-center-configuration-information processing unit 311 transmits data-center configuration information 321 to the client 201.

In step S605, the NW-response-table processing unit 312 receives the NW response table 233 from the client 201 and stores this table in the storage unit 318 as the NW response table 322. The server-response-table processing unit 313 receives the server response table 235 from the client 201 and stores this table in the storage unit 318 as the server response table 323.

In step S606, the sort processing unit 316 generates a sorted NW response table by sorting the records within the NW response table 322 in ascending order of network response time. The sort processing unit 316 generates a sorted server response table by sorting the records within the server response table 323 in ascending order of server response time. The sort processing unit 316 generates a sorted free-disk-capacity table by sorting the records within the free-disk-capacity table 324 in descending order of free disk capacity.

In step S607, the NW-response-table processing unit 312 transmits the sorted NW response table to the client 201. The server-response-table processing unit 313 transmits the sorted server response table to the client 201. The free-disk-capacity-table processing unit 314 transmits the sorted free-disk-capacity table to the client 201.

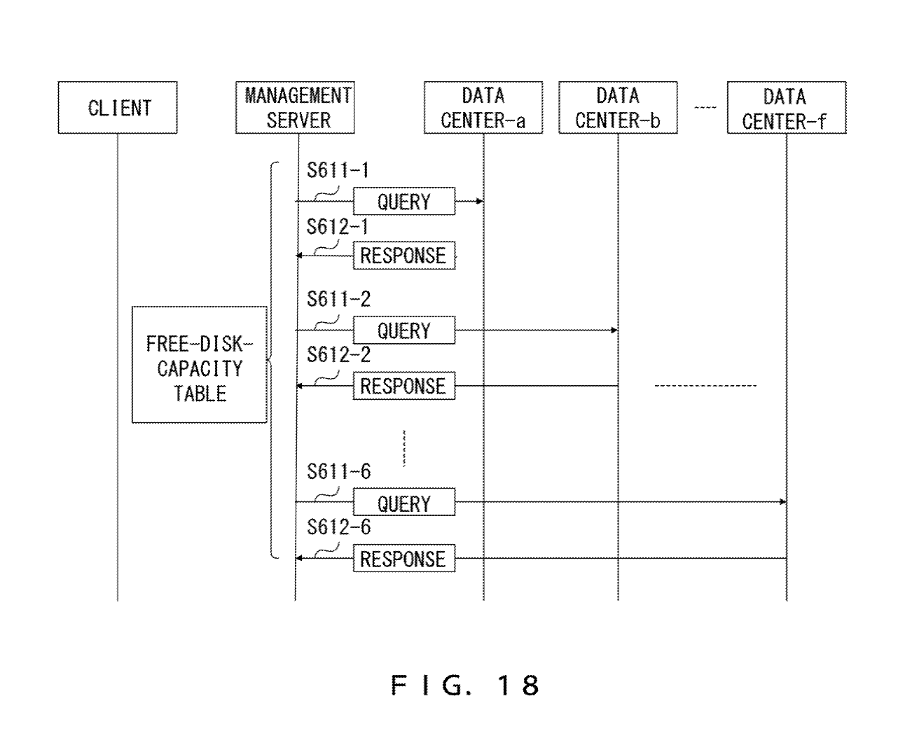

FIG. 18 is a sequence diagram of a process of obtaining information on a free disk capacity in accordance with an embodiment.

FIG. 18 corresponds to step S601 in FIG. 17.

The disk-capacity inquiring unit 315 transmits to the data center 401-1 a free-disk-capacity checking request to inquire about a free disk capacity (step S611-1).

The disk-capacity inquiring unit 315 receives a free-disk-capacity response (size of free disk capacity) from data center 401-1 (step S612-1). The free-disk-capacity-table processing unit 314 receives and stores information on the free disk capacity of the data center 401-1 in the free-disk-capacity table 324.

The disk-capacity inquiring unit 315 similarly transmits free-disk-capacity checking requests to the data centers 401-2 to 401-6 in order and receives and stores information on the free disk capacities of the data centers 401-2 to 401-6 in the free-disk-capacity table 324 (steps S611-2 to S612-6).

Next, descriptions will be given of a process performed by the data centers 401. The data centers 401-1 to 401-6 perform similar processes, and, accordingly, only the process performed by the data center 401-1 will be described.

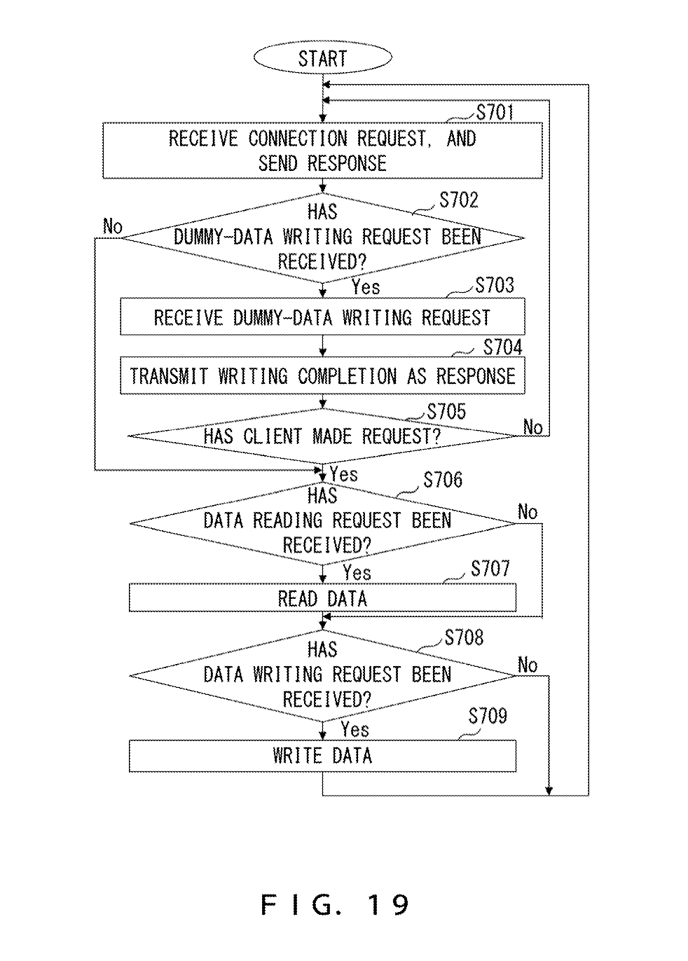

FIG. 19 is a flowchart of a client response process performed by a data center in accordance with an embodiment.

In step S701, the NIC 416 receives a connection request (SYN packet) from the client 201 and transmits an ACK (ACK packet) to the client 201.

In step S702, when the data center 401-1 receives a dummy-data writing request, the flow shifts to step S703; otherwise, the flow shifts to step S706.

In step S703, the dummy-data-writing processing unit 414 receives the dummy-data writing request from the client 201.

In step S704, the dummy-data-writing processing unit 414 writes dummy data to the storage unit 417. Then, the dummy-data-writing processing unit 414 transmits a writing completion to the client 201 as a response.

In step S705, when the data center 401-1 receives a data reading request or data writing request, the flow shifts to step S706; otherwise, the flow returns to step S701.

In step S706, when the data-reading processing unit 412 receives a data reading request, the flow shifts to step S707; otherwise, the flow shifts to step S708.

In step S707, the data-reading processing unit 412 reads, from the storage unit 417, data requested by the data reading request and transmits the data to the client 201.

In step S708, when the data-writing processing unit 413 receives a data writing request, the flow shifts to step S709; otherwise, the flow returns to step S701. When the data-writing processing unit 413 receives a data writing request, the data-writing processing unit 413 receives a piece of divided data as data to be written to the storage unit 417.

In step S709, the data-writing processing unit 413 writes the piece of divided data to the storage unit 417.

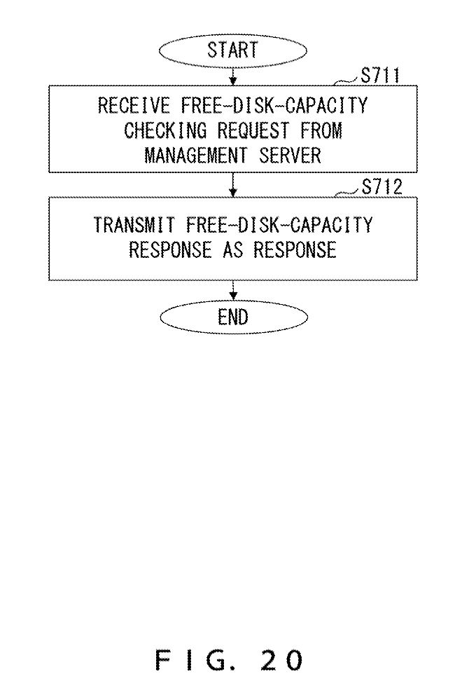

FIG. 20 is a flowchart of a management-server response process performed by a data center in accordance with an embodiment.

The disk-capacity-checking processing unit 411 receives a free-disk-capacity checking request from the management server 301 and checks a free disk capacity of the storage unit 417 (step S711).

The disk-capacity-checking processing unit 411 reports the size of the free disk capacity of the storage unit 417 to the management server 301 as a free-disk-capacity response (step S712).

The following will describe two examples with respect to a process of selecting a saving data center.

(1) Network Response Time has Precedence

First, a process of selecting a saving data center in accordance with a network response time will be described as a first example.

In the first example, the name of writing data 231 is “Abc”, and writing data 231 is divided into two pieces of divided data. The names of the two pieces of divided data are “Abc-1” and “Abc-2”.

Three data centers are used as saving data centers.

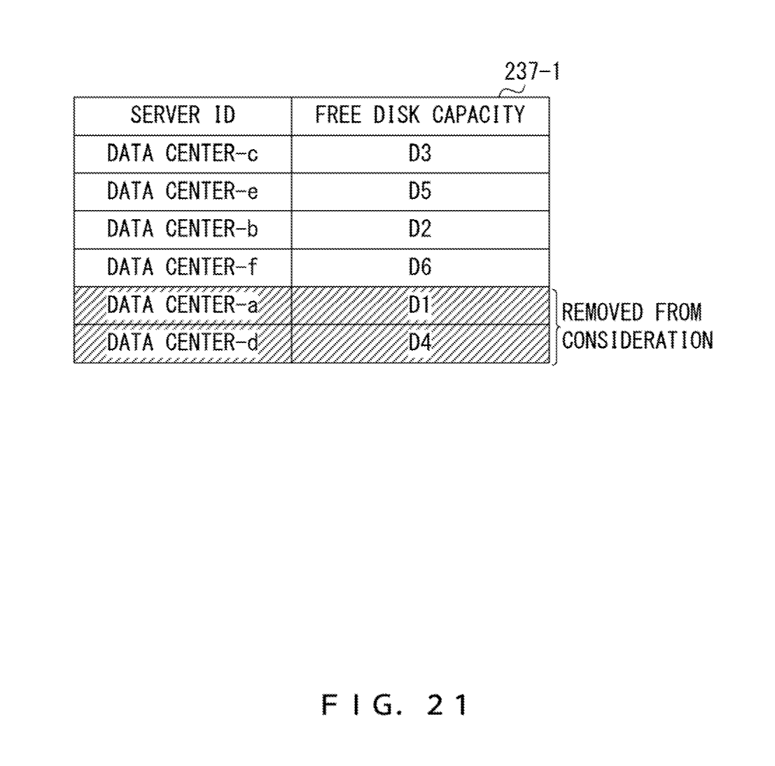

FIG. 21 illustrates a sorted free-disk-capacity table.

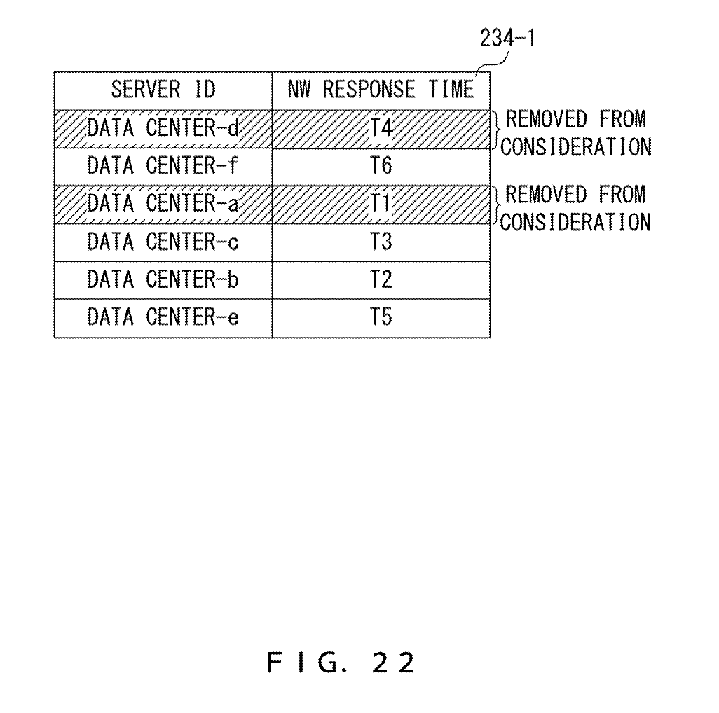

FIG. 22 illustrates a sorted NW response table.

In the first example, the sorted free-disk-capacity table 237-1 and the sorted NW response table 234-1 are respectively arranged as illustrated in FIGS. 21 and 22. Data-center configuration information 232 is arranged as depicted in FIG. 3.

The destination-to-save-data selecting processing unit 217 refers to the sorted free-disk-capacity table 237-1 and makes settings while removing data centers whose free disk capacity is equal to or less than a predetermined value (e.g., equal to or less than 10 G) from consideration. Data centers whose free disk capacity is equal to or less than a predetermined value are removed from saving data centers so that existing data stored in the data centers can be corrected or written.

Assume that the data center-a and the data center-d have been removed from consideration.

The destination-to-save-data selecting processing unit 217 refers to and causes the sorted NW response table 234-1 to reflect information on the data centers that have been removed from consideration. That is, the data center-a and the data center-d are set in the sorted NW response table 234-1 as data centers that have been removed from consideration.

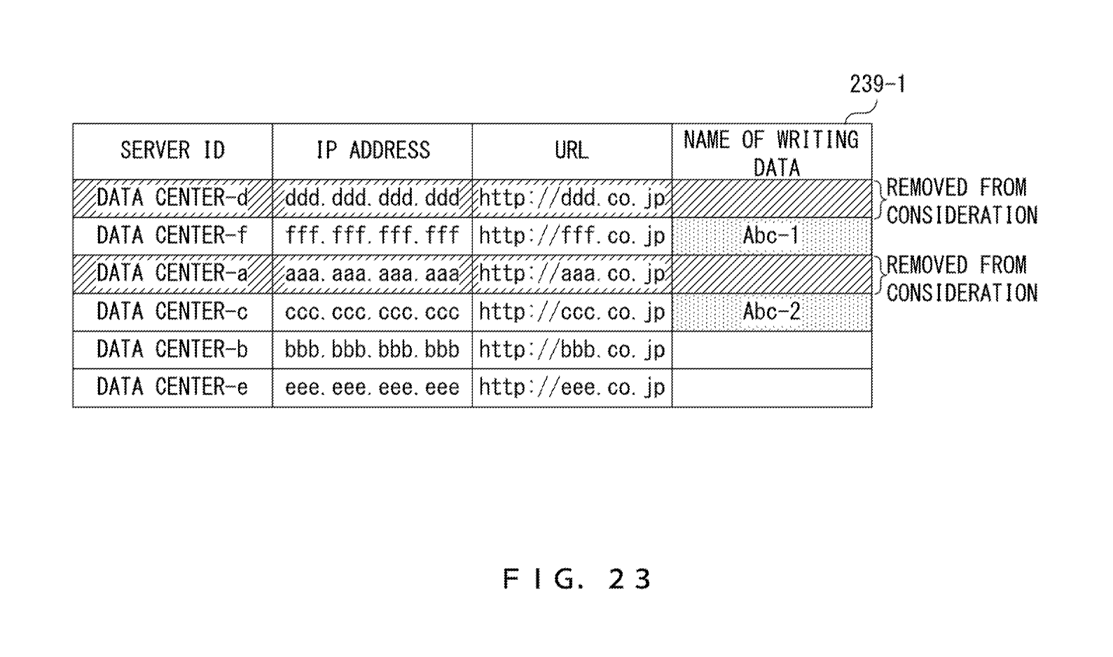

The destination-to-save-data selecting processing unit 217 creates the divided-data management table 239-1 depicted in FIG. 23 using data-center configuration information 232 and the sorted NW response table 234-1. Assume that data has not been written as a name of writing data.

In the divided-data management table 239-1, server IDs are ordered starting from the server ID with the fastest NW response time.

The destination-to-save-data selecting processing unit 217 selects three data centers with the first to third fastest NW response times from the data centers registered in the divided-data management table 239-1 except for the data centers that have been removed from consideration, and defines these three data centers as saving data centers. That is, the data center-f, the data center-c, and the data center-b are selected.

In addition, pieces of divided data are allocated to the saving data centers starting from the saving data center with the fastest NW response time.

Accordingly, the pieces of divided data “Abc-1” and “Abc-2” are respectively allocated to the data center-f and the data center-c.

The destination-to-save-data selecting processing unit 217 registers “Abc-1” and “Abc-2” in the divided-data management table 239-1 as the names of writing data corresponding to the data center-f and the data center-c, respectively. This creates the divided-data management table 239-1 as depicted in FIG. 23. The destination-to-save-data selecting processing unit 217 saves the divided-data management table 239-1 in the storage unit 220 in association with the data name “Abc”.

The data reading/writing processing unit 218 transmits the pieces of divided data “Abc-1” and “Abc-2” to the data center 401-6 and the data center 401-3, respectively.

When another writing request is made, data centers are cyclically used in order of, for example, data center-b→ data center-f→ • • •.

(2) Server Response Time has Precedence

Next, a process of selecting a saving data center in accordance with a server response time will be described as a second example.

In the second example, the name of writing data 231 is “Def”, and writing data 231 is divided into three pieces of divided data. The names of the three pieces of divided data are “Def-1”, “Def-2”, and “Def-3”.

Three data centers are used as saving data centers.

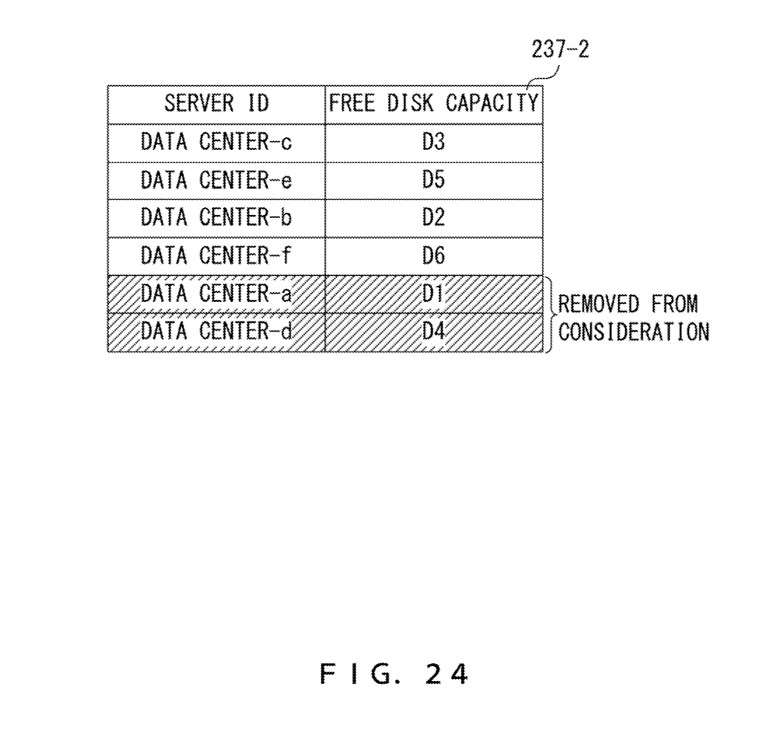

FIG. 24 illustrates a sorted free-disk-capacity table.

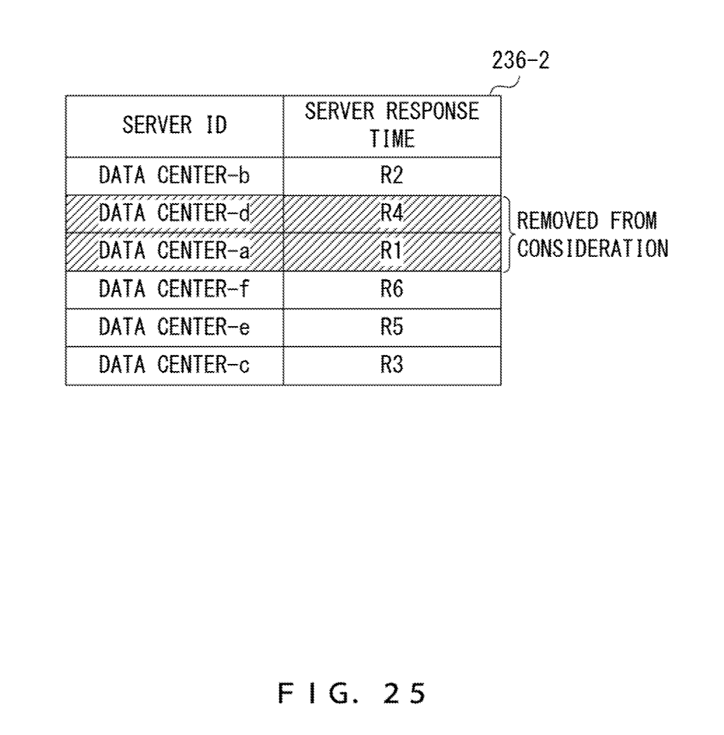

FIG. 25 illustrates a sorted server response table.

In the second example, the sorted free-disk-capacity table 237-2 and the sorted server response table 236-2 are respectively arranged as illustrated in FIGS. 24 and 25. Data-center configuration information 232 is arranged as depicted in FIG. 3.

The destination-to-save-data selecting processing unit 217 refers to the sorted free-disk-capacity table 237-2 and makes settings while removing data centers whose free disk capacity is equal to or less than a predetermined value (e.g., equal to or less than 10 G) from consideration. Data centers whose free disk capacity is equal to or less than a predetermined value are removed from saving data centers so that existing data stored in the data centers can be corrected or written.

Assume that the data center-a and the data center-d have been removed from consideration.

The destination-to-save-data selecting processing unit 217 refers to and causes the sorted server response table 236-2 to reflect information on the data centers that have been removed from consideration. That is, the data center-a and the data center-d are set in the sorted server response table 236-2 as data centers that have been removed from consideration.

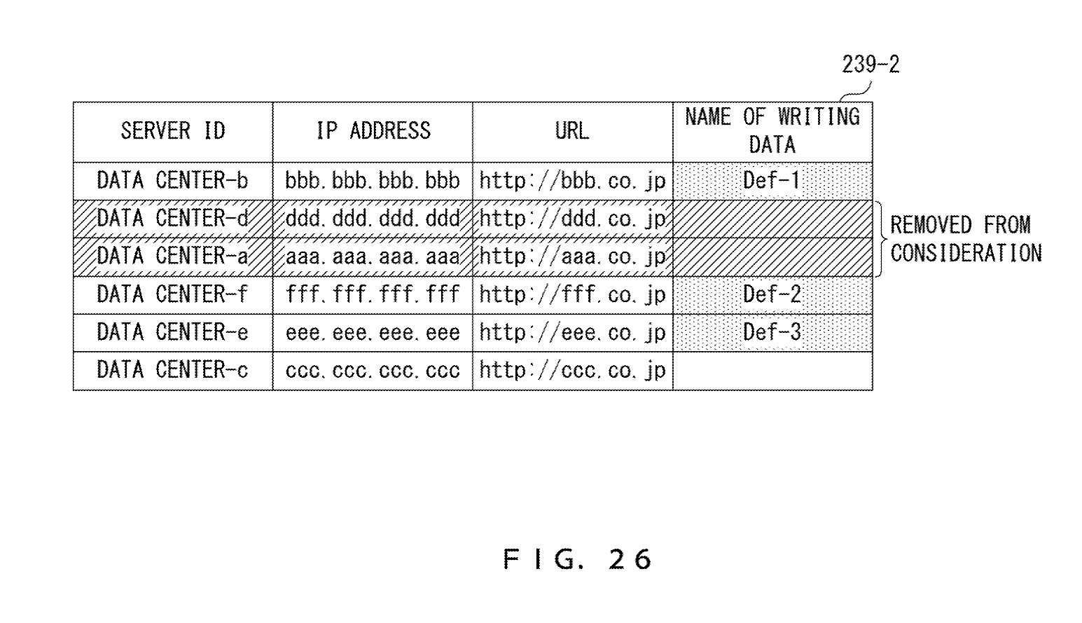

The destination-to-save-data selecting processing unit 217 creates the divided-data management table 239-1 depicted in FIG. 26 using data-center configuration information 232 and the sorted server response table 236-2. Assume that data has not been written as a name of writing data.

In the divided-data management table 239-1, server IDs are ordered starting from the server ID with the fastest server response time.

The destination-to-save-data selecting processing unit 217 selects three data centers with the first to third fastest server response times from the data centers registered in the divided-data management table 239-2 except for the data centers that have been removed from consideration, and defines these three data centers as saving data centers. That is, the data center-b, the data center-f, and the data center-e are selected.

In addition, pieces of divided data are allocated to the saving data centers starting from the saving data center with the fastest NW response time.

Accordingly, the pieces of divided data “Def-1”, “Def-2”, and “Def-2” are respectively allocated to the data center-b, the data center-f, and the data center-e.

The destination-to-save-data selecting processing unit 217 registers “Def-1”, “Def-2”, and “Def-3” in the divided-data management table 239-2 as the names of writing data corresponding to the data center-b, the data center-f, and the data center-e, respectively. This creates the divided-data management table 239-2 as depicted in FIG. 26. The destination-to-save-data selecting processing unit 217 saves the divided-data management table 239-2 in the storage unit 220 in association with the data name “Def”.

The data reading/writing processing unit 218 transmits the pieces of divided data “Def-1”, “Def-2”, and “Def-3” to the data center 401-2, the data center 401-6, and the data center 401-5, respectively.

When another writing request is made, data centers are cyclically used in order of, for example, data center-b→ data center-f→ • • •.

The following will describe a process of reading data.

When the client 201 needs data saved in the data centers 401, the data reading/writing processing unit 218 reads pieces of divided data from the data centers 401 and combines these pieces. This generates the data before division.

When, for example, the client 201 needs data with the data name “Abc”, the data reading/writing processing unit 218 refers to the divided-data management table 239-1, i.e., a table associated with the data name “Abc”.

As depicted in FIG. 23, the divided-data management table 239-1 indicates that the pieces of divided data “Abc-1” and “Abc-2” are respectively stored in the data centers 401-6 and 401-3.

Accordingly, the data reading/writing processing unit 218 reads the pieces of divided data “Abc-1” and “Abc-2” from the data centers 401-6 and 401-3, respectively, and generates the data “Abc”, i.e., the data before division, by combining the pieces of divided data “Abc-1” and “Abc-2”.

In this way, the data reading/writing processing unit 218 refers to the divided-data management table 239, identifies data centers 401 storing pieces of divided data, reads the pieces of divided data from the identified data centers 401, and combines the pieces of divided data to generate the data before division.

The system in accordance with the embodiment allows the client to select a data center that does not take a long time to complete a data saving process.

In the system in accordance with the embodiment, data is divided into a plurality of pieces, which are stored in different data centers, thereby decreasing a load applied to a particular data center.

The system in accordance with the embodiment may decrease the time required to complete the data saving process.

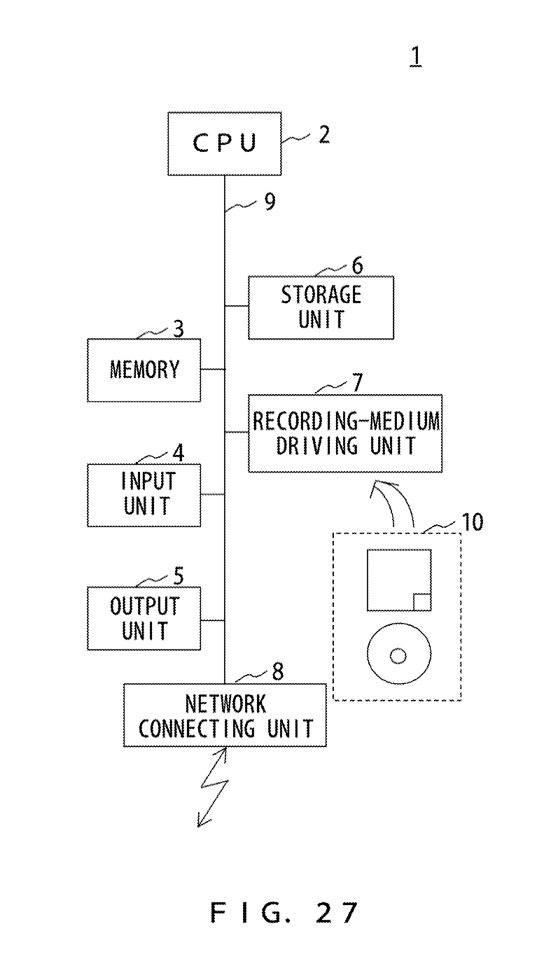

FIG. 27 is a configuration diagram of an information processing apparatus (computer).

The client 201, the management server 301, and the data center 401 of the embodiment may be achieved by, for example, an information processing apparatus 1 depicted in FIG. 27.

The information processing apparatus 1 includes a CPU 2, a memory 3, an input unit 4, an output unit 5, a storage unit 6, a recording-medium driving unit 7, and a network connecting unit 8, all of which are connected to each other by a bus 9.

The CPU 2 controls the entirety of the information processing apparatus 1. The CPU 2 corresponds to the data-center-configuration-information obtaining unit 211, the dummy-data-writing-request processing unit 212, the NW-response-table processing unit 213, the server-response-table processing unit 214, the sort-table-reception processing unit 215, the data-division processing unit 216, the destination-to-save-data selecting processing unit 217, the data reading/writing processing unit 218, the transmission and reception controlling unit 219, the NW-response-table processing unit 312, the server-response-table processing unit 313, the free-disk-capacity-table processing unit 314, the disk-capacity inquiring unit 315, the sort processing unit 316, the transmission and reception controlling unit 317, the disk-capacity-checking processing unit 411, the data-reading processing unit 412, the data-writing processing unit 413, the dummy-data-writing processing unit 414, and the transmission and reception controlling unit 415.

The memory 3 is, for example, a Read Only Memory (ROM) or RandomAccess Memory (RAM) that, during execution of a program, temporarily stores a program or data stored in the storage unit 6 (or portable recording medium 10). The CPU 2 performs the aforementioned various processes by using the memory 3 to execute programs.

In this case, program codes read from, for example, the portable recording medium 10 themselves achieve the functions of the embodiment.

The input unit 4 is, for example, a keyboard, mouse, or touch panel.

The output unit 5 is, for example, a display or printer.

The storage unit 6 is, for example, a magnetic disk apparatus, optical disk apparatus, or tape apparatus. The information processing apparatus 1 saves the aforementioned programs and data in the storage unit 6 and reads and loads a program or data into the memory 3 on an as-needed basis.

The memory 3 or the storage unit 6 corresponds to the storage units 220, 318, and 417.

The recording-medium driving unit 7 drives the portable recording medium 10 and accesses information recorded therein. The portable recording medium may be an arbitrary computer-readable recording medium such as a memory card, flexible disk, Compact Disk Read Only Memory (CD-ROM), optical disk, or magnet optical disk. The user saves the aforementioned programs and data in the portable recording medium 10 and reads and loads a program or data into the memory 3 on an as-needed basis.

The network connecting unit 8 is connected to an arbitrary communication network such as a LAN and converts data in accordance with a communication. The network connecting unit 8 corresponds to the NIC 416.

All examples and conditional language provided herein are intended for pedagogical purposes to aiding the reader in understanding the invention and the concepts contributed by the inventor to further the art, and are not to be construed as being limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus that is capable of communicating with a plurality of servers, the information processing apparatus comprising:
a storage unit to store
a network response table describing a network response time, the network response time being a time period from transmission of a request to establish a connection to a server to reception of a response to the request to establish the connection, and
a server response table describing a server response time, the server response time being a time period from transmission of a request to write data to the server to reception of a response indicating a completion of writing the data; and
a processor to generate pieces of divided data by dividing writing data, select, in accordance with the network response time or the server response time, saving servers in which the pieces of the divided data are to be saved, and transmit the pieces of the divided data to the saving servers.

2. The information processing apparatus according to claim 1, wherein
the processor measures the network response time.

3. The information processing apparatus according to claim 1, wherein
the processor measures the server response time.

4. The information processing apparatus according to claim 1, wherein
the storage unit further stores a division-condition table describing a size of writing data and a size of a piece of divided data in association with each other, and
the processor generates the pieces of divided data in accordance with the division-condition table.

5. The information processing apparatus according to claim 1, wherein
the processor selects the saving servers starting from a saving server having a shortest network response time.

6. The information processing apparatus according to claim 1, wherein
the processor selects the saving servers starting from a saving server having a shortest server response time.

7. The information processing apparatus according to claim 1, wherein
the storage unit stores a free-capacity table describing free capacities of the plurality of servers, and
the processor selects, as a saving server, a server whose free capacity is greater than a threshold.

8. A non-transitory computer-readable recording medium having stored therein a program for causing a computer to perform a data saving method, the computer being capable of communicating with a plurality of servers and including a storage unit storing a network response table describing a network response time, the network response time being a time period from transmission of a request to establish a connection to a server to reception of a response to the request to establish the connection, and a server response table describing a server response time, the server response time being a time period from transmission of a request to write data to the server to reception of a response indicating a completion of writing the data, the data saving method including,
generating, by a processor, pieces of divided data by dividing writing data,
selecting, by the processor, in accordance with the network response time or the server response time, saving servers in which pieces of the divided data are to be saved, and
transmitting, by the processor, the pieces of the divided data to the saving servers.
